(19) United States
(12) Patent Application Publication
(10) Pub. No.: US 2016/0380914 A1
(43) Pub. Date: Dec. 29, 2016

(54) METHOD AND APPARATUS FOR PROVIDING RESOURCE LOAD DISTRIBUTION FOR EMBEDDED SYSTEMS

(71) Applicant: HERE Global B.V., Veldhoven (NL)

(72) Inventor: Marko Tapio TUUKKANEN, Schlenzer (DE)

(21) Appl. No.: 14/750,691

(22) Filed: Jun. 25, 2015

(51) Int. Cl. H04L 12/911; H04L 29/08

(52) U.S. Cl. CPC H04L 47/783; H04L 67/16

(57) ABSTRACT

An approach is provided for determining resource availability information, resource capability information, or a combination thereof associated with at least one embedded system, at least one device with connectivity to the at least one embedded system, or a combination thereof. The approach involves causing, at least in part, a transfer of one or more services of the at least one embedded system to the at least one device based, at least in part, on the resource availability information, resource capability information, or a combination thereof. The approach also involves causing, at least in part, a transmission of one or more service information updates to the at least one embedded system following the transfer. The one or more service information updates are used by the at least one embedded system to resume the one or more services when the one or more services are no longer provided by the at least one device.

### BACKGROUND

Service providers and device manufacturers (e.g., wireless, cellular, etc.) are continually challenged to deliver value and convenience to consumers by, for example, providing compelling services. One area of interest has been the implementation of these services using embedded systems. However, as the level of sophistication of these services increases (e.g., services related to providing autonomous or highly automated vehicles), so can the resource requirements (e.g., computing resources, memory resources, etc.) for providing the services. The increased resource requirements, in turn, can increase the resource load on the underlying embedded systems. Accordingly, service providers and device manufacturers face significant technical challenges with integrating the resources available from user devices with the built-in resources of embedded systems to provide services to users.

### Some Example Embodiments

Therefore, there is a need for an approach for providing efficient resource load distribution for embedded systems.

According to one embodiment, a method comprises determining resource availability information, resource capability information, or a combination thereof associated with at least one embedded system, at least one device with connectivity to the at least one embedded system, or a combination thereof. The method also comprises causing, at least in part, a transfer of one or more services of the at least one embedded system to the at least one device based, at least in part, on the resource availability information, resource capability information, or a combination thereof. The method further comprises causing, at least in part, a transmission of one or more service information updates to the at least one embedded system following the transfer. The one or more service information updates are used by the at least one embedded system to resume the one or more services when the one or more services are no longer provided by the at least one device

According to another embodiment, an apparatus comprises at least one processor, and at least one memory including computer program code for one or more computer programs, the at least one memory and the computer program code configured to, with the at least one processor, cause, at least in part, the apparatus to determine resource availability information, resource capability information, or a combination thereof associated with at least one embedded system, at least one device with connectivity to the at least one embedded system, or a combination thereof. The apparatus is also caused to cause, at least in part, a transfer of one or more services of the at least one embedded system to the at least one device based, at least in part, on the resource availability information, resource capability information, or a combination thereof. The apparatus is further caused to cause, at least in part, a transmission of one or more service information updates to the at least one embedded system following the transfer. The one or more service information updates are used by the at least one embedded system to resume the one or more services when the one or more services are no longer provided by the at least one device.

According to another embodiment, a computer-readable storage medium carries one or more sequences of one or more instructions which, when executed by one or more processors, cause, at least in part, an apparatus to determine resource availability information, resource capability information, or a combination thereof associated with at least one embedded system, at least one device with connectivity to the at least one embedded system, or a combination thereof. The apparatus is also caused to cause, at least in part, a transfer of one or more services of the at least one embedded system to the at least one device based, at least in part, on the resource availability information, resource capability information, or a combination thereof. The apparatus is further caused to cause, at least in part, a transmission of one or more service information updates to the at least one embedded system following the transfer. The one or more service information updates are used by the at least one embedded system to resume the one or more services when the one or more services are no longer provided by the at least one device.

According to another embodiment, an apparatus comprises means for determining resource availability information, resource capability information, or a combination thereof associated with at least one embedded system, at least one device with connectivity to the at least one embedded system, or a combination thereof. The apparatus also comprises means for causing, at least in part, a transfer of one or more services of the at least one embedded system to the at least one device based, at least in part, on the resource availability information, resource capability information, or a combination thereof. The apparatus further comprises means for causing, at least in part, a transmission of one or more service information updates to the at least one embedded system following the transfer. The one or more service information updates are used by the at least one embedded system to resume the one or more services when the one or more services are no longer provided by the at least one device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-49.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of efficient resource load distribution for embedded systems, according to one embodiment;

FIG. 1B is a diagram of the geographic database, according to exemplary embodiments;

FIG. 2A is a diagram of the components of a resource allocation manager, according to one embodiment;

FIG. 2B is a diagram of the components of a user equipment, according to an embodiment;

FIG. 3 is a flowchart of a process for efficient resource load distribution for embedded systems, according to one embodiment;

FIG. 4 is a flowchart of a process for determining the transfer of one or more services based on a threshold, according to one embodiment;

FIG. 5 is a flowchart of optional processes used for causing a transfer or retention of one or more alert messages, according to one embodiment;

FIG. 6 is a flowchart of a process for determining additional items to be processed and the transfer of the additional items, according to one embodiment;

FIGS. 7A and 7B include flowchart diagrams for utilizing one or more processes of FIGS. 3 through 6, for efficient resource load distribution for embedded systems, according to various embodiments;

FIGS. 8A through 8C are user interface diagrams for efficient resource load distribution for embedded systems, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing efficient resource load distribution for embedded systems are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

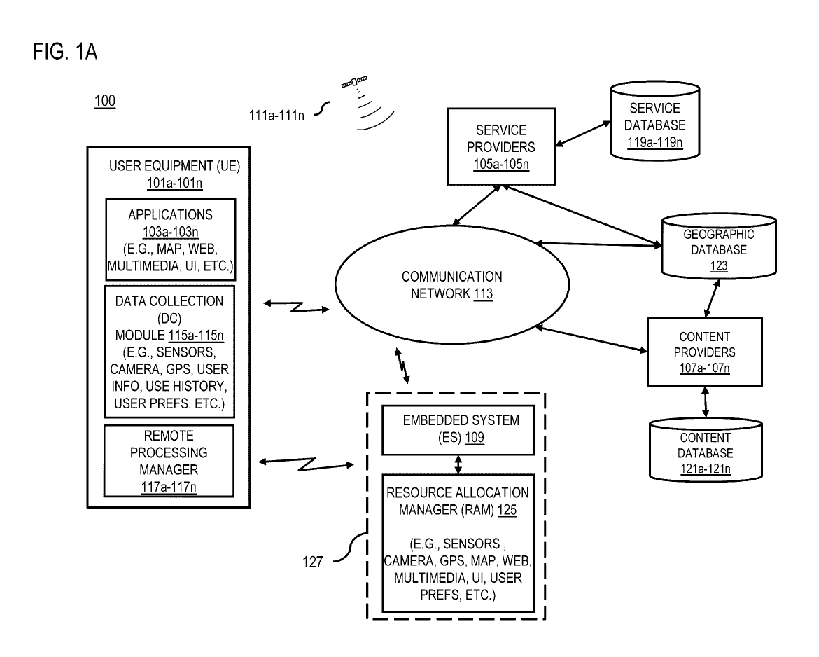

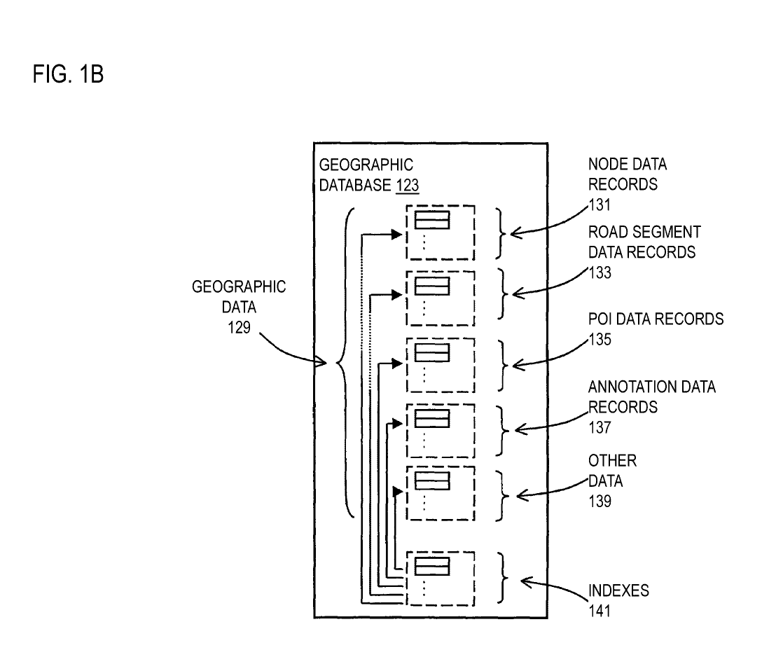

FIG. 1A is a diagram of a system capable of providing efficient resource load distribution for embedded systems, according to one embodiment. Traditionally, many in-vehicle services, including support for navigation, execution of various applications, and other services, may employ various resources that may be available through embedded systems that are designed to be incorporated in the vehicle. In some instances, an embedded system may interact or include on-board computers, navigation systems, various sensors, storage devices (e.g., memory chips, hard drives, etc.), various applications/software, or the like components that may be utilized to support various critical and non-critical operations of the vehicle as well as to provide various services (e.g., information, entertainment, etc.) for users in the vehicle. As some (e.g., connected, smart, etc.) vehicles are designed to be increasingly autonomous or semi-autonomous, there are increasing demands on resources of embedded systems in the vehicles; for example, to have higher storage and processing capacities for capturing, storing, and analyzing critical/imminent and non-critical/non-imminent information related to vehicle sensor systems and a variety of services. Consequently, such vehicles increasingly require more hardware, memory and other like components for improved functionalities of embedded systems and operation of the vehicles. Further, add-on devices, such as Global Navigation Satellite System (GNSS), e.g., a Global Positioning System (GPS), or similar systems, may add to the load on an on-board embedded system when the add-on devices are used in conjunction with other on-board systems. Additionally, as lifecycle of an embedded system/vehicle may be much longer than the lifecycle of user devices (e.g., smartphones, tablets, laptops, etc.), some user devices may include newer and more advanced features/capabilities than an embedded system/vehicle. For example, processing power, memory, network connectivity or other capabilities in newer user devices may not have even been invented when the embedded system/vehicle was manufactured.

Furthermore, the amount of available information for management of autonomous/semi-autonomous vehicles is increasing at a rate that may be challenging to correlate by an embedded system of a vehicle. Moreover, in some instances, some embedded systems may not be able to support certain newer functionalities in a vehicle system. For example, some navigation systems (e.g., existing or newer) cannot support more than one destination for a multi-waypoint navigation routing. However, some of these embedded navigation systems can support third-party applications, which can interact with the local embedded navigation system database for supporting multi-waypoint navigation routing.

To address, at least, these problems, a system 100 introduces a capability for providing efficient resource load distribution for embedded systems. With advances in and prevalence of electronic user devices (e.g., smartphones, tablets, portable computers, etc.), many users carry/use such devices while in a vehicle. In some instances, it may be advantageous to distribute non-critical operations/processes of an embedded system of a vehicle to user devices available in the vehicle for improving the capacity and efficiency of the embedded system. It is further recognized that the capacity and efficiency gained by incorporating additional processing from available user devices are properly balanced so to maintain the most critical and immediate functions on-board the embedded system in the event that the processes at the user devices (remote processes) may, even if temporarily, be interrupted or lost. Thus, by distributing some processes of an embedded system of a vehicle to available user devices, the embedded system may have an improved computing capacity and performance, which may reduce the required on-board processing, equipment, and cost as well as contribute to improved operations of the vehicle and a better user experience. In one embodiment, the system 100 may assess processes at an embedded system of a vehicle to determine those that are critical and non-critical, respectively, to operations at the vehicle. Of the non-critical processes (e.g. non-driving related), assessments may be made continuously to determine a priority and/or an immediacy of each process. By way of example, the processes deemed critical may include driving related functions, such as ADAS (advanced driver assistance system), navigation or location information of imminent relevance, and/or other functions that are more relevant to the immediate physical environment and/or nearer in time (service information of nearby roads and locations, etc.). Contrarily, the non-critical functions may include non-driving related functions (e.g. weather information, music, entertainment, search for information, etc.) of peripheral relevance, and/or other functions that are not relevant to the immediate physical environment and/or not near in time (service information for distant roads and locations). Embodiments and examples of these functions are discussed in more detail below.

In one embodiment, to allow creation of multi-waypoint routes via a user device (e.g., other than an embedded system), a user can use a user device application for creating a route, which may be synchronized with a one or more applications (e.g., navigation, map, location-based services, etc.) running in the embedded navigation system. In one scenario, the application may set the destination on the embedded navigation system database, but as the vehicle reaches the waypoint/destination, the application may replace the current waypoint/destination with the next one along the route. In another scenario, a user may create a multi-waypoint route via an embedded system in the vehicle, wherein the user can create the route using a third-party application that can update the embedded navigation system database as the vehicle/user reaches the waypoint/destination.

In one embodiment, the system 100 determines transfer criteria of one or more services. The transfer criteria includes a determination of how imminent or immediately relevant an embedded system process or function is for driving. These driving functions may not be subject to transfer due to their immediate importance. Furthermore, non-driving functions may or may not be subject to transfer criteria depending on one or more determinations of the criticality of the function (e.g. services). In one embodiment, the transfer criteria can be determined with respect to a number of factors including a criticality of the one or more services, a distance threshold, a combination thereof, and other like criteria.

Based on the transfer criteria, including the criticality of non-driving related functions, the system 100 may transfer one or more services of at least one embedded system to at least one device based, at least in part, on resource availability/capability information. The at least one device, such as mobile devices (e.g. cell phone, iPad, etc.), must include a connectivity to the embedded system. Furthermore, the at least one device must include an adequate capacity to support any non-driving functions that may be transferred. As discussed, any non-critical function that may be transferred must not be imminent for vehicle systems or the user of the vehicle systems. Thus, the embedded system (on-board vehicle systems) processes are analyzed to determine the least critical functions that may be transferred to the at least on mobile device.

In this way, the system 100 may cause a transfer of one or more processes/services of the embedded system to the at least one device based on a resource availability/capability, such as the device's capacity to process non-critical processes/services. Furthermore, the system 100 may cause a transmission of service information updates from the at least one device back to the embedded system as a means of integrating the systems—embedded and device systems, respectively. For example, in one embodiment, the service information updates may be used to resume the processes/services if they are not able to be performed by the (mobile) device (e.g., connection lost, low capacity, low battery, etc.)

As shown in FIG. 1A, in one embodiment, the system 100 includes user equipment (UE) 101a-101n (also collectively referred to as a UE 101 and/or UEs 101), which may be utilized to execute one or more applications 103a-103n (also collectively referred to as applications 103) including navigation application, security applications, games, social networking, web browser, media application, user interface (UI), map application, web client, etc. to communicate with other UEs 101, one or more service providers 105a-105n (also collectively referred to as service provider/providers 105), one or more content providers 107a-107n (also collectively referred to as content provider/providers 107), an embedded system (ES) 109, one or more satellites 111a-111n (also collectively referred to as the satellite system 111), and/or with other components of a the system 100 directly and/or over a communication network 113.

In one embodiment, the UEs 101 may include data collection modules 115a-115n (also collectively referred to as DC module 115) for determining and/or collecting data associated with the UEs 101, one or more sensors of the UE 101, one or more users of the UEs 101, applications 103, or the like information.

In one embodiment, the UEs 101 may include remote processing manager 117a-117n (also collectively referred to as a remote processing manager 117) for receiving a process/task from the service providers 105, the ES 109, etc., and managing execution of process. Also, the remote processing manager 117 may submit a process/task request to one or more entities of the system 100. In one embodiment, the remote processing manager 117 may utilize one or more algorithms, applications, software programs, and the like to associate various criteria with a process request from the ES 109, e.g., to monitor the one or more distance threshold value and execute one or more related executable commands or actions. In various embodiments, the remote processing manager 117 may further determine one or more executable commands based on one or more request criteria, wherein the commands may be associated with determining processes, interrupting processes, and transferring various process results, status, and the like. In one embodiment, the remote processing manager 117 may be configured to determine information from sensors associated with the ES 109 and/or the UE 101, one or more accounts associated with the ES and/or the UE 101, or the like.

In one embodiment, the service providers 105 may include and/or have access to one or more service databases 119a-119n (also collectively referred to as service database 119), which may include various mapping data, user information, user profiles, user preferences, one or more profiles of one or more user devices (e.g., device configuration, sensors information, etc.), information on the service providers 105, and the like. In one embodiment, the service providers 105 may include one or more service providers offering one or more services, for example, location based services, navigation services, autonomous driving services, social networking services, content sharing, account management services, or a combination thereof.

In one embodiment, the content providers 107 may include and/or have access to one or more content database 121a-121n (also collectively referred to as content database 121), which may store, include, and/or have access to various content items. For example, the content providers 107 may store content items (e.g., at the content database 121) provided by various users, various service providers, crowd-sourced content, or the like. Further, the service providers 105 and/or the content providers 107 may utilize one or more service application programming interfaces (APIs)/integrated interface, through which communication, media, content, and information (e.g., associated with users, applications, services, content, etc.) may be shared, accessed and/or processed.

In various embodiments, the service providers 105 and/or the content providers 107 may include and/or have access to a geographic database 123, which may include information (e.g., points of interest (POIs), objects, weather, people, etc.) associated with given geographical areas. The information may be available from various public, private, or government controlled databases, where the information may be requested or accessed by one or more entities of the system 100 via the communication network 113. In one embodiment, the system 100 includes an infrastructure for sharing geospatial information in real-time on multiple devices that includes a map-based service, application, and/or web interface that may provide various map UIs. By way of example, the map-based service, application, and/or interface can be provided over the communication network 113 by the service providers 105.

In one embodiment, the ES 109 may interface with or include a resource allocation manager (RAM) 125, where both may be implemented on-board a vehicle 127; for example, an automobile, a boat, a plane, or the like. The RAM 125 may discover and interact with one or more UEs 101 that may be within its close proximity. In one scenario, a RAM 125 onboard a vehicle may discover one or more UEs 101 that may be in the vehicle and determine resource availability/capability information associated with the UEs 101. Further, the RAM 125 may determine if there are any current, pending, or upcoming processes, tasks, services, etc. that the ES 109 may be responsible to execute. As discussed, the processes may be associated with various operations or services associated with the vehicle and/or one or more users in the vehicle.

In one embodiment, the RAM 125 may interact with the UEs 101 (e.g., via the remote processing manager 117) to manage one or more ES 109 services (e.g. non-driving and non-critical process) as described above. For example, when a vehicle is traveling along a travel route, the RAM 125 may determine the criticality of the non-driving services as well as resource availability/capability information for one or more UEs 101; for example, if the services are non-critical, then they may be allocated to the UEs 101 accordingly.

In one example, the RAM 125 may determine resource availability/capability information (e.g., when an on-board navigation application is in use) associated with an ES 109. If an available UE 101 has a connection (e.g., wireless, wired, etc.) to the RAM 125 and is available to perform the required services/processes, then the navigation application service may be transferred to the UE 101. In one embodiment, a plurality of services may be transferred to a single UE 101. This information may be communicated to and/or received from the RAM 125 and/or other UEs 101. As such, the RAM 125 may manage the processing of non-driving functions, and/or other user information to ensure the resource allocation is performed efficiently. Thus, RAM 125 may determine a transfer of one or more services of the ES 109 to the UEs 101, while also causing a transmission of one or more service information updates from or by the UEs 101 to the ES 109. As previously discussed, a transfer of services may be determined using a criteria of a criticality of the services, contextual situation information, a distance threshold (as relates to navigation and location information), or another like criteria.

In one embodiment, the RAM 125 may cause one or more services, such as alert services. As discussed, the one or more non-critical services or events, such as the non-driving services and/or non-critical driving services, may be allocated based on the degree of criticality thereof. If the non-critical service is of immediate application for the ES 109 or for accessibility for one or more users, it may be retained for processing within the ES 109. Such may be the case for the non-critical events of greater criticality. This is to prevent the loss of information that might otherwise result from processing on a mobile device. For example, an alert service (navigational, location related, sensor related, etc.) may be retained at the ES 109 for detecting alert events within a given distance threshold. Furthermore, alert services pertaining to events or potential events outside the distance threshold may be transferred to one or more UEs 101, since such events are deemed to include a lower level of criticality outside the distance threshold. In addition or alternatively, each UE 101 may be configured for different services, and/or different levels of criticality, distance thresholds, and other like constraints for one or more services and/or applications (e.g., applications 103a-103n) to allocate and/or process.

In one embodiment, the RAM 125 may be configured to interface directly with the service providers 105 for various map, location-based, and/or other related services. In addition, the RAM 125 and/or the service providers 105 may interface with one or more content providers 107 that can provide/deliver content of various types and genres (e.g., geospatial information, mapping content, navigation content, travel content, locality content, marketing content) upon request. Requests may be initiated via the communication network 113 by way of one or more location based applications 103 executing on the UEs 101 that are further associated with respective users. By way of example, the applications 103 may access turn-by-turn navigation, routing information, maps, driving instructions, etc., for accessing, annotating, and/or sharing geospatial information. In one embodiment, the RAM 125 can store and/or retrieve geospatial information, service information, and/or other related information in a geographic database 123 (further described below with respect to FIG. 1B).

In one embodiment, the system 100 includes software to enhance the applications 103, the service providers 105, the content providers 107, and/or any other component of the system 100 to provide efficient resource load distribution for an ES 109. It is contemplated that the service information need not be associated with a navigational route. Accordingly, in one embodiment, the system 100 can be used to provide entertainment and/or other services of relevance to a user. In one embodiment, the service information may be saved on the participating users' UEs 101. In one embodiment, other users may be able to access a user's route information, service information, estimated time of arrival, sharing information, location sharing information, speed sharing information, and other like user/vehicle service information. In one embodiment, the system 100 may automatically detect the receiving or participating devices by, e.g., querying for device identifiers, user identifiers, etc. associated with a vehicle resource allocation system.

By way of example, resource availability/capability information includes, but is not limited to, information related to services, processing capacity, memory capacity, navigational service information, and other like information. Such information may be gathered as resource availability/capability information or to supplement preexisting information, and may further include service criticality information, route information, traffic information, weather information, estimated time of arrival sharing information, distance threshold information, and other like information. In one embodiment, resource availability/capability information may include a number of forms including annotations related to service information, route information, location, logos, visual images, acronyms, and other like forms which may indicate resource availability/capability information.

In one embodiment, the transfer of one or more services as part of the resource allocation protocol between the embedded system and the device are based on one or more transfer criteria. As discussed, the transfer criteria may include a variety of factors. In one scenario, the transfer criteria may depend on the criticality of one or more services. If the criticality is above a threshold, the one or more services will be considered to have greater immediacy or imminence and, thus, be retained in the embedded system. If the criticality is below a threshold, the one or more services will be considered to have lower immediacy or imminence and, thus, may be transferred to the at least one device. In another scenario, the criticality of one or more services may be determined based on a distance threshold, such as may be relevant for navigation information, location information, ADAS information, autonomous vehicle management information, and other like distance dependent services. The one or more services may have various and specific distance threshold values, which may depend on the criticality of the specific service. Thus, within a distance threshold, the one or more services will be considered to have greater immediacy or imminence and, thus, be retained in the embedded system. And, beyond the distance threshold, the one or more services will be considered to have low immediacy or imminence and, thus, be retained in the embedded system.

In another scenario, the criticality of one or more services may be determined based on contextual situations that make the services of greater immediacy or immanence including speed related factors, road related features (e.g., curvature), type of the road (e.g. highway, rural road) weather, and other like factors. Furthermore, the one or more services may be partitioned between driving-related services and non-driving related services. Thus, the driving-related services will be more retained in the embedded system due to the greater immediacy thereof while the non-driving related services may be transferred to the at least one device. For example, the driving-related service may be applicable to the operation of an autonomous or semi-autonomous vehicle, such as may be the case for a navigation service. In some scenarios, the one or more services may have both the non-critical and critical service features based on the distance threshold, e.g., detection of the ADAS information within the distance threshold can be critical and out of the distance threshold and it may be non-critical.

In one embodiment, the one or more services that are not imminent within the distance threshold are subject to transfer from the at least one embedded system to the at least one device. In one scenario, one or more alerts services may be retained at the embedded system for detecting one or more alert events within the distance threshold. Thus, alert events may be able to be anticipated within the distance threshold without relying on the least one device which may have a lower reliability for processing such alert events. Furthermore, the system 100 may cause a transfer of the one or more alert services from the embedded system to the at least one device for detecting alert events outside of the distance threshold. Thus, the alert events of lower immediacy may be processed by the at least one device. Such alert events are not as immediately relevant and may be able to be taken over by the embedded system or another device if the connection is lost or if a processing failure occurs. In one scenario, the system 100 may cause the transmission of one or more alert messages to the at least one embedded system if the at least one device detects the alerts outside of the distance threshold. In some scenarios, the embedded system may discard alerts that are no longer relevant while accepting new alerts from the at least one device that are of recent relevance.

In one embodiment, the resource availability information and/or resource capability information may include information specifying a maximum number of items that can be processed by the embedded system and the actual number of items to process. In one scenario, the system 100 may determine if the actual number of items is greater than the maximum number of items. If so, the system 100 may further create a processing queue of the actual number of items at the at least one device, and another processing queue of the maximum number of items at the at least one embedded system. In one scenario, the system 100 may cause a transfer of one or more items from the at least one processing queue at the at least one device to the another processing queue at the at least one embedded system as the at least one embedded system processes and removes one or other items from the another processing queue. In other words, the embedded system may only include a set number of items of greater criticality or immediacy. For example, if the number of items exceeds this set maximum number, the additional items may be sent to the queue of at least one device for eventual processing. The items may be stored as a queue for the embedded system and the at least one device, respectively. When the queue of the embedded system is depleted below the maximum number of items, additional items may be transferred from the queue of the at least one device to the queue of the embedded system for a maintenance of the maximum number of items.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as communication services (e.g., texting applications, calling applications, etc.), location-based service applications, navigation applications, camera/imaging application, media player applications, social networking applications, calendar applications, and the like. In one embodiment, one of the applications 103 at the UE 101 may act as a client for the RAM 125 and perform one or more functions of the RAM 125. In one scenario, users are able to select a destination via one or more map applications. In one embodiment, one or more receivers of the UE 101 may process route information including resource availability/capability information for presentation at the receiving device.

By way of example, the UEs 101 may include various sensors that may include a camera/imaging sensor for gathering image data, an audio recorder for gathering audio data, a global positioning sensor for gathering location data, a network detection sensor for detecting wireless signals or network data, temporal information and the like for use as annotations. In one embodiment, the sensors may include, light sensors, orientation sensors augmented with height sensor and acceleration sensor, tilt sensors, moisture sensors, pressure sensors, audio sensors (e.g., microphone), or receivers for different short-range communications (e.g., Bluetooth, Wi-Fi, etc.) In one scenario, the one or more sensors may detect attributes for mapping or routing (e.g., one or more modes of transportation).

The communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the components of the system 100 communicate with each other and other components using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of the geographic database 123 of system 100, according to various embodiments. In the embodiments, resource availability/capability information as well as a transfer of one or more services can be stored, associated with, and/or linked to the geographic database 123 or data thereof. In one embodiment, the geographic or map database 123 includes geographic data 129 used for (or configured to be compiled to be used for) mapping and/or navigation-related services, such as for route information, service information, estimated time of arrival information, location sharing information, speed sharing information, and/or geospatial information sharing, according to exemplary embodiments. For example, the geographic database 123 includes node data records 131, road segment or link data records 133, POI data records 135, annotation data records 137, other data records 139, for example, wherein an index 141 may provide additional information about the records/data. More, fewer or different data records can be provided. In one embodiment, the other data records 139 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 133 are links or segments representing roads, streets, or paths, as can be used in the calculated route or recorded route information for efficient resource load distribution for embedded systems, according to exemplary embodiments. The node data records 131 are end points corresponding to the respective links or segments of the road segment data records 133. The road link data records 133 and the node data records 131 represent a road network, such as used by vehicles, cars, and/or other entities. Alternatively, the geographic database 123 can contain path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 135. The geographic database 123 can also include data about places, such as cities, towns, or other communities, and other geographic features, such as bodies of water, mountain ranges, etc. Such place or feature data can be part of the POI data 135 or can be associated with POIs or POI data records 135 (such as a data point used for displaying or representing a position of a city).

The geographic database 123 can be maintained by the content providers 107 in association with the service providers 105 (e.g., a map developer). A map developer can collect geographic data to generate and enhance the geographic database 123. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 123 can be a master geographic database stored in a format that facilitates updating, maintenance, and development. For example, the master geographic database 123 or data in the master geographic database 123 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data or geospatial information is compiled (such as into a platform specification format (PSF) format) to organize and/or configure the data for performing map or navigation-related functions and/or services, such as map annotation, route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 123 can be a master geographic database, but in alternate embodiments, the geographic database 123 can represent a compiled navigation database that can be used in or with end user devices (e.g., UEs 101) to provide navigation-related functions. For example, the geographic database 123 can be used with the end user device 101 to provide an end user with navigation features. In such a case, the geographic database 123 can be downloaded or stored on the end user device UE 101, such as in applications 103, or the end user device UE 101 can access the geographic database 123 through a wireless or wired connection (such as via a server and/or the communication network 113), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for ranking of one or more road links.

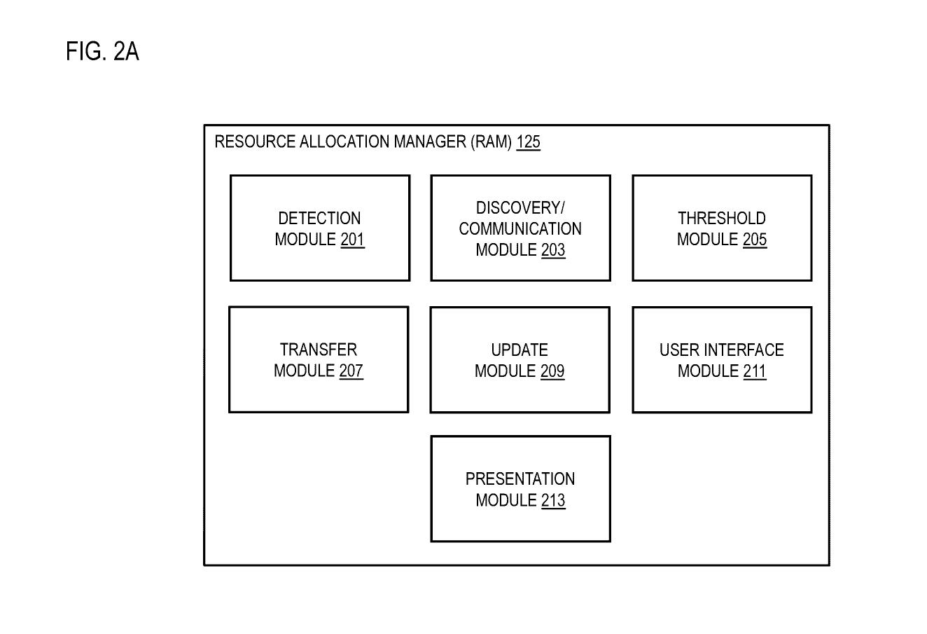

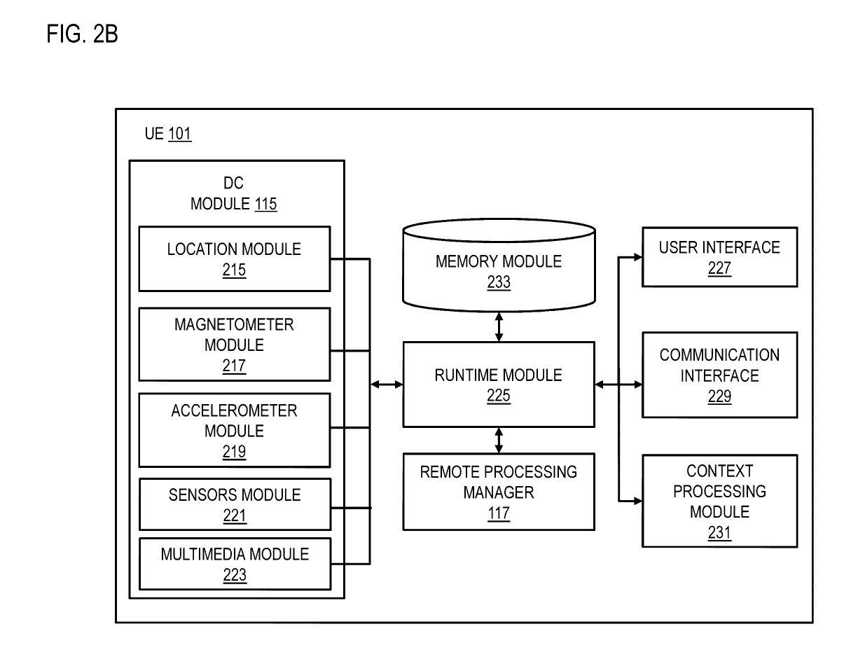

FIG. 2A is a diagram of the components of a resource allocation manager 125, according to one embodiment. By way of example, the RAM 125 includes one or more components for providing efficient resource load distribution for embedded systems. It is contemplated that the functions of these components may be combined in one or more components or performed by other components of equivalent functionality. In one embodiment, the RAM 125 includes a detection module 201, a discovery/communication module 203, a threshold module 205, a transfer module 207, an update module 209, a user interface module 211, and a presentation module 213, or a combination thereof.

In one embodiment, the detection module 201 includes system algorithms, sensors, access to car sensor information, network databases, and/or one or more third-party content providers, such as content providers 107 for detecting resource availability/capability information of one or more services. The resource availability/capability information may in part include transfer criteria includes a determination of how imminent or immediately relevant a vehicle system process or function is for driving. These driving functions may not be subject to transfer from an embedded system to a device due to their immediate importance. The detection module may detect user driving information, contextual information, or a combination thereof. The detection module may communicate with the one of the other modules to, at least in part, determine resource availability/capability information.

In one embodiment, a discovery/communication module 203 may discover and establish a communication session with one or more near-by UEs 101. For example, the discovery/communication module 203 may utilize one or more a proximity-based communication protocols to scan for and discover any target UEs 101 that may be in the vehicle. In one embodiment, an ES 109 may already have established communication sessions with one or more other devices for one or more services, for example, that may have been initiated by the UE 101 or its user. In one embodiment, a communication session between the discovery/communication module 203 and a UE 101 may be using a non-pairing communication protocol to establish a proximity-based communication session with a UE 101, where it may not be required to perform a device-pairing process (e.g., passwords, passcodes, etc.) For example, the discovery/communication module 203 may request a communication session with the UE 101, wherein a communication component on the UE 101 may establish the communication session without a need for a user on the UE 101 device to perform any process steps in accepting or completing the process. In one instance, discovery/communication module 203 and a UE 101 may utilize prior communication session information.

In one embodiment, the threshold module 205 includes an integrated system for optimizing a resource allocation for vehicle services by using one or more thresholds to determine the priority of one or more services. Such threshold and/or service information may be stored in an on-board systems database, gathered from a platform or network, modified manually, accessed when prompted by an application 103, or gathered from devices or sensors incorporated into the detection module 201 and processed via the transfer module 207. The threshold module 205 may also be used to assess various factors that may be used to determine one or more thresholds including a distance threshold, a criticality threshold, or another like parameter. This threshold information may be further modified by user preferences and tolerances, which, in part, provide route information for the at least one user.

In one embodiment, the transfer module 207 may process the outputs of the detection module 201 and threshold module 205 as well as information from other modules for determining transfer criteria. In one scenario, non-driving functions may or may not be subject to transfer criteria depending on one or more determinations of the criticality of the function. In one embodiment, the transfer criteria of can be determined with respect to a number of factors including a threshold criticality of the one or more services, a distance threshold, a combination thereof, and other like criteria. The transfer module 207 may transfer one or more services of at least one embedded system to at least one device based, at least in part, on resource availability/capability information. This transfer information may also be integrated with the detection module 201, the threshold module 205, and update module 209 to fully integrate the transfer information with the service information and threshold information. These determinations may be constructed based on a manual user input, system setting, or as part of a machine learning algorithm. In one scenario, the transfer module 207 may provide feedback iteratively to the detection module 201, the threshold module 205 or one of the other modules.

In some embodiments, the update module 209 may process the output information of the detection module 201, the threshold module 205, and transfer module 207 to cause updating as resource available information changes for one or more services, a threshold, criticality, and other like information. The update module 209 integrates the detection module 201, threshold module 205, and transfer module 207 as resource allocation information is assessed for multiple vehicle services. Likewise, the update module 209 may cause a transmission of service information updates from or by at least one device back to the embedded system and vice versa as a means of integrating the systems—embedded and device systems, respectively. For example, in one embodiment, the service information updates may be used to resume services if the services are not able to be performed on a UE 101; for example, due to communication connection lost, low capacity, low battery, etc.

In one embodiment, the user interface module 211 may be configured for exchanging information between a UE 101 and the geographic database 123, and/or one or more content providers 107. In another embodiment, the user interface module 211 enables presentation of a graphical user interface (GUI) for displaying a presentation of the one or more vehicle services, the one or more users, or a combination thereof. For example, the user interface module 211 executes a GUI application configured to provide users with up to date resource availability/capability information. The user interface module 211 employs various application programming interfaces (APIs) or other function calls corresponding to the applications 103 of UE 101, thus enabling the display of graphics primitives such as menus, buttons, data entry fields, etc., for generating the user interface elements. Still further, the user interface module 211 may be configured to operate in connection with augmented reality (AR) or virtual reality (VR) processing techniques, wherein various applications, graphic elements and features may interact. For example, the user interface module 211 may coordinate the presentation of resource availability/capability information for a given vehicle service. In a further embodiment, the user interface module 211 may cause an interfacing of the resource availability/capability information with one or more users to include, at least in part, one or more annotations, audio messages, voice messages, or a combination thereof.

In one embodiment, the presentation module 213 may process the outputs of the user interface module 211 as well as information from other modules for a determination if the information meets a threshold of relevance, and a presentation of the resource availability/capability information through an at least one embedded system, at least one device or a combination thereof. For instance, the presentation module 213 may output resource availability/capability information according to the relevance to one or more users, personal preference criteria, and other like factors. This resource availability/capability information may be in the form of annotations, audio, video, or a combination thereof, and may be determined by a manual user input, an automatic determination, or a combination thereof. Also, the presentation module 213 may include an algorithm for a presentation of the resource availability/capability information on the embedded system or on the at least one device. In one scenario, the presentation module 213 may provide feedback iteratively to one of the other modules based on user feedback or other system requirements. In another embodiment, the presentation module 213 may cause a presentation of content information in the most suitable manner for a consistent user experience.

FIG. 2B is a diagram of the components of a user equipment capable of receiving and processing of one or more services/tasks from one or more systems/devices, according to an embodiment. By way of example, a UE 101 includes one or more components for receiving and transmitting communication information including remote service/process requests, media content, textual messages, location information, and the like. It is contemplated that the functions of these components may be combined in one or more components or performed by other components of equivalent functionality. In this embodiment, the UE 101 includes a DC module 115 that may include one or more location modules 215, magnetometer modules 217, accelerometer modules 219, sensors module 221, and multimedia module 223. Further, the UE 101 may also include a runtime module 225 to coordinate the use of other components of the UE 101, a user interface 227, a communication interface 229, a context processing module 231, and a memory module 233. The applications 103 and the remote processing manager 117 can execute on the runtime module 225 utilizing the components of the UE 101.

The location module 215 can determine location of a user, for example, via location information associated with a UE 101 of the user. The user's location can be determined by a wireless network triangulation system, GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 215 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory module 233 and are available to the context processing module 231, DC module 115, ES 109, RAM 125, service providers 105, or to other entities of the system 100 (e.g., via the communication interface 229). Moreover, in certain embodiments, the GPS coordinates can include an altitude to provide a height. In other embodiments, the altitude can be determined using another type of altimeter. In certain embodiments, the location module 215 can be a means for determining a location of the UE 101, an image, or used to associate an object in view with a location.

The magnetometer module 217 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory module 233, made available to other modules and/or applications 103 of the UE 101, and/or transmitted via the communication interface 229 to one or more entities of the system 100.

The accelerometer module 219 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 219 can determine the angle the UE 101 is pointed as compared to Earth's gravity. In certain embodiments, the magnetometer module 217 and accelerometer module 219 can be means for ascertaining a perspective of a user. This perspective information may be stored in the memory module 233, made available to other modules and/or applications 103 of the UE 101, and/or sent to one or more entities of the system 100.

In various embodiments, the sensors module 221 can process sensor data from various sensors (e.g., GPS, accelerometer, gyroscope, thermometer, etc.) to determine environmental (e.g., atmospheric) conditions surrounding the UE 101, user mood (e.g., hungry, angry, tired, etc.), location information, and various other information from a range sensors that may be available on one or more devices. For example, the sensors module 221 may detect conditions including humidity, temperature, geo-location, biometric data of the user, etc. Once again, this information can be stored in the memory module 233 and sent to the remote processing manager 117 and/or to other entities of the system 100. In certain embodiments, information collected from the DC module 115 can be retrieved by the runtime module 225 and stored in the memory module 233, made available to other modules and/or applications 103 of the UE 101, or sent to one or more entities of the system 100. Additionally, the sensors module 221 may have access to the sensor information from the vehicle.

In one embodiment, the multimedia module 223 may be utilized to capture various media items, for example, graphical encoded data representations, images, video, audio, and the like, wherein the captured media may be submitted to one or more modules and applications of the UE 101, a service provider, and/or a content provider for further processing, storage, sharing, and the like. For example, a captured image of graphical encoded data representations may be submitted to a service provider and/or the remote processing manager 117 for analysis and/or decoding. In one embodiment, the multimedia module 223 may also be utilized to process various media items for determining location information associated with a media content item. For example, a media item may be a picture that may include images of people, POIs, objects, buildings, etc. In one embodiment, the multimedia module 223 may use one or more image processing algorithms for processing a media item and for identifying one or more elements present into media item.

The user interface 227 can include various methods of communication. For example, the user interface 227 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

In one embodiment, the communication interface 229 can be used to communicate with one or more entities of the system 100. Certain communications can be via methods such as an internet protocol, messaging (e.g., SMS, MMS, etc.), or any other communication method (e.g., via the communication network 113). In some examples, the UE 101 can send context information associated with the UE 101 to the service providers 105, content providers 107, RAM 125, or to other entities of the system 100.

The context processing module 231 may be utilized in determining context information from the DC module 115 or applications 103 executing on the runtime module 225. This information may be caused to be transmitted, via the communication interface 229, to the RAM 125, service providers 105 or to other entities of the system 100. The context processing module 231 may additionally be utilized as a means for determining information related to the user, an instance of data, a value, a content item, an object, a subject, and the like. In certain embodiments, the context processing module 231 can infer higher level context information from the context data such as favorite locations, significant places, common activities, interests in products and services, POIs at various geo-locations, etc.

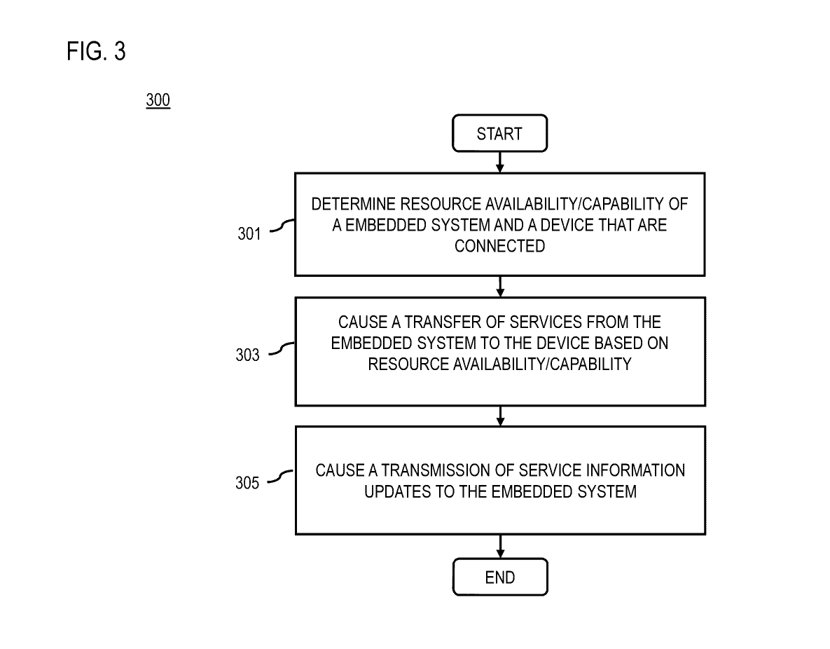

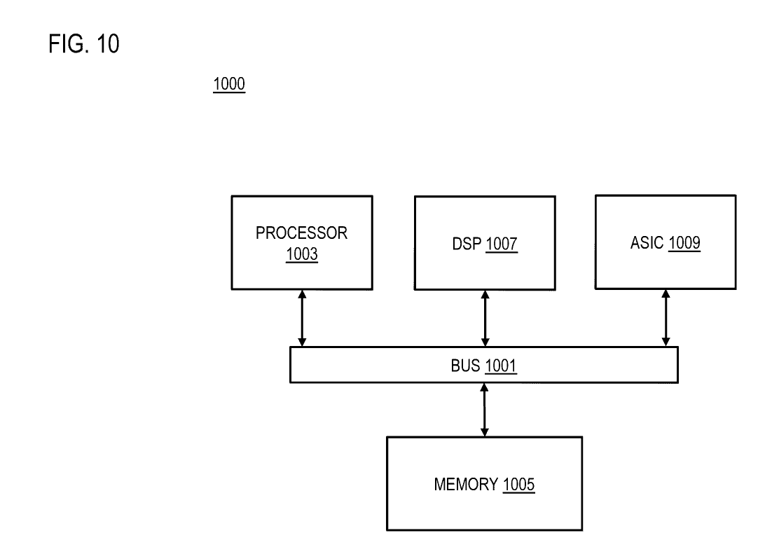

FIG. 3 is a flowchart of a process for efficient resource load distribution for embedded systems, according to one embodiment. In one embodiment, RAM 125 performs the process 300 and is implemented in, for instance, a chip set including a processor and a memory as shown in FIG. 10.

The process 300 may begin at step 301, where the RAM 125 may determines resource availability/capability and/or resource capability information associated with at least one embedded system, at least one device with connectivity to the at least one embedded system, or a combination thereof. In one embodiment, the resource availability/capability is assessed for the embedded system (on-board system) and/or one or more devices (mobile device, phone, etc.). The resource availability/capability may include one or more functions related to one or more services. In one scenario, these functions may include a processing power, memory, ability to analyze sensor information, computation capacity, and other like capabilities. In one embodiment, the RAM 125 may evaluate the embedded and device systems using a variety of applications or algorithms known in the art to determine the capabilities of at least one embedded system 109 and/or at least one UE 101.

In step 303, the RAM 125 may cause, at least in part, a transfer of one or more services of the at least one embedded system to the at least one device based, at least in part, on the resource availability/capability information. In one embodiment, the RAM 125 and/or user may determine the device(s) to allocate one or more service or service related resource. In one embodiment, one or more services may be transferred including route information, estimated time of arrival sharing information, location sharing information, speed sharing information, traffic information, weather information, a combination thereof, and other like service related information. In one scenario, the device may be connected to the driver by way of a log-in or other authenticating mechanism known in the art. In one scenario, the RAM 125 may select any device available in the car including smart phones, tablets, a combination, and other like devices (e.g., UE 101) with sufficient processing capacity to process the one or more services. This resource availability/capability and/or transfer information may be communicated to and/or received from the RAM 125 and/or other UEs 101.

In step 305, the RAM 125 may cause, at least in part, a transmission of one or more service information updates from or by the at least one device to the at least one embedded system following the transfer. In one embodiment, the RAM 125 may cause a transmission of numerous updates from the at least one device to the at least one embedded system. These updates may be based on the processing capability, memory, and/or connection status for the devices. In one scenario, the RAM 125 may determine the various services or alerts the at least one device may provide to the embedded system and, as such, the updates may include the availability/capability of one or more services. In one scenario, the one or more services will be non-critical and not directly related to the driving function of an autonomous or semi-autonomous vehicle. Therefore, the at least one device may handle the processing or operation of such services. In one scenario, however, the at least one device may no longer perform the one or more services, and the transmission of an update may cause the embedded system to perform or resume performing the processing of the one or more service.

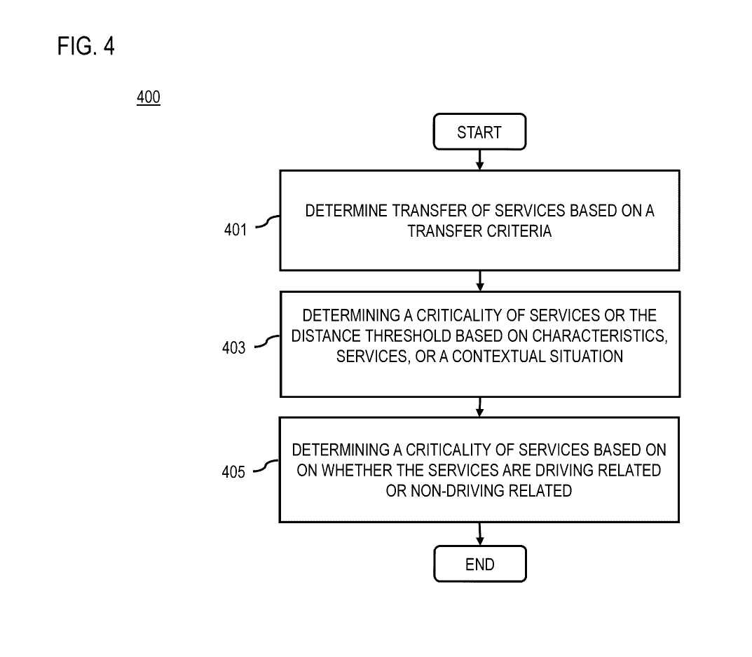

FIG. 4 is a flowchart of a process for determining the transfer of one or more services based on a threshold, according to one embodiment. In one embodiment, the RAM 125 performs the process 400 and is implemented in, for instance, a chip set including a processor and a memory as shown in FIG. 10. In one embodiment, the steps of the process 400 are optional steps that can be performed in combination with one or more steps of the process 300 of FIG. 3.

The process 400 may begin at step 401, where the RAM 125 determines transfer of the one or more services based, at least in part, on one or more transfer criteria. In one embodiment, the one or more transfer criteria may include, at least in part, a criticality of the one or more services, a distance threshold, or a combination thereof. The criticality is the immediacy or relevance of the one or more services to the vehicle system and/or user. As previously discussed, the transfer criteria may include an assessment to determine the critical or non-critical functions for driving operations. In one scenario, the critical functions are not subject to transfer while the non-critical functions may or may not be transferred based on the immanency or criticality thereof. This way, the one or more services that are less critical may be transferred to the one or more devices. In one embodiment, the criticality may be determined using a distance threshold. Thus, one or more services pertaining to location information within the distance threshold may be processed by the embedded system, while one or more services pertaining to location information outside the distance threshold may be processed by the at least one device. For example, the RAM 125 may assess information associated with a number of navigation waypoint items and navigation viapoint items. For navigation waypoint items and navigation viapoint items within a previously determined distance threshold, the navigation waypoint item and navigation viapoint item information is not subject to transfer and may be processed by the at least one embedded system. For navigation waypoint items and navigation viapoint items outside the previously determined distance threshold, the navigation waypoint item and navigation viapoint item information may then be subject to transfer to the at least one device.

In step 403, the RAM 125 determines the criticality of the one or more services, the distance threshold, or a combination thereof based, at least in part, on one or more characteristics of the one or more services, one or more contextual situations, or a combination thereof. In one embodiment, one or more characteristics of one or more services may determine the criticality of the services. Such characteristics may be related to an immediacy, a context, an efficiency a user preference, a combination thereof, or other like characteristics as may relate to the embedded system, the at least one device, one or more users, a combination thereof, and other like factors. In one embodiment, the criticality of one or more services may be determined based on contextual situations. Such contextual situations may include wherein the one or more services are of greater immediacy or immanence. Also, the contextual situations may include a speed of the vehicle, weather factors, traffic situations, and other like factors.

In step 405, the RAM 125 determines the criticality of the one or more services based, at least in part, on whether the one or more services are driving-related or non-driving related. In one embodiment, the RAM 125 may partition the one or more services between driving-related services and non-driving related services. Thus, the driving-related services will be retained in the embedded system due to the greater immediacy and criticality thereof while the non-driving related services may be transferred to the at least one device. For example, the driving-related service may be applicable to the operation of an autonomous or semi-autonomous vehicle, such as may be the case for a navigation service.

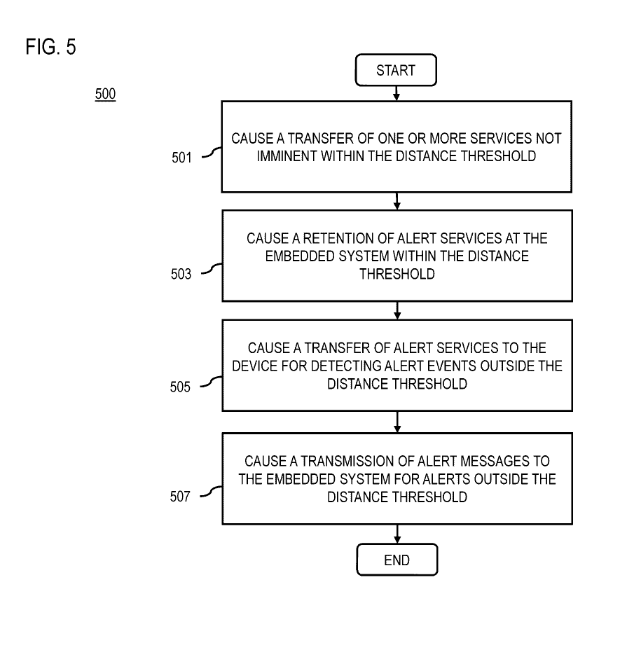

FIG. 5 is a flowchart of optional processes used for causing a transfer or retention of one or more alert messages, according to one embodiment. In one embodiment, the user interface platform performs the process 500 and is implemented in, for instance, a chip set including a processor and a memory as shown in FIG. 10.

The process 500 may begin at step 501, where the RAM 125 may cause, at least in part, the one or more services that are not imminent within the distance threshold to be subject to transfer from the at least one embedded system to the at least one device. In one embodiment, the RAM 125 may determine the immanency of one or more services by using at least one distance threshold for the one or more services. In one embodiment, the more immanent functions that are immediately critical may not subject to transfer, while less imminent functions that are not as critical may or may not be transferred. Thus, in one scenario, the one or more services below a prescribed immanency may be transferred to the at least one device. In one embodiment, the immanency may be determined using a distance threshold. Thus, one or more services pertaining to location information within the distance threshold may be processed by the embedded system, while one or more services pertaining to location information outside the distance threshold may be processed by the at least one device. For example, the RAM 125 may assess information associated with a number of navigation waypoint items and navigation viapoint items. For navigation waypoint items and navigation viapoint items within a previously determined distance threshold, the navigation waypoint item and navigation viapoint item information is not subject to transfer and may be processed by the at least one embedded system. For navigation waypoint items and navigation viapoint items outside the previously determined distance threshold, the navigation waypoint item and navigation viapoint item information may then be subject to transfer to the at least one device.

In step 503, the RAM 125 may cause, at least in part, a retention of the one or more alert services at the at least one embedded system for detecting one or more alert events within the distance threshold. In one embodiment, one or more alerts services may be retained at the embedded system for detecting one or more alert events within the distance threshold. In one scenario, the alert events may be able to be anticipated within the distance threshold without relying on the least one device which may have a lower reliability for processing such alert events. In one scenario, the RAM 125 may cause a transfer of the one or more alert services from the embedded system to the at least one device for detecting alert events outside of the distance threshold. Thus, the alert events of lower immediacy may be processed by the at least one device. Such alert events are not as immediately relevant and may be able to be taken over by the embedded system or another device if the connection is lost or if a processing failure occurs. In one scenario, the system 100 may cause the transmission of one or more alert messages from the at least one device to the at least one embedded system if the at least one device detects the alerts outside of the distance threshold. In some scenarios, the embedded system may discard alerts that are no longer relevant while accepting new alerts from the at least one device that are of recent relevance.

In step 505, the RAM 125 may cause, at least in part, a transfer of the one or more alert services to the at least one device for detecting one or more alert events outside of the distance threshold. In one embodiment, the RAM 125 may cause a transfer of the one or more alert services from the embedded system to the at least one device for detecting alert events outside of the distance threshold. Thus, in one scenario, the alert events of lower immediacy may be processed by the at least one device. In one scenario, the alert events are not as immediately relevant and may be able to be taken over by the embedded system or another device if the connection is lost or if a processing failure occurs. In another scenario, the alert events may be resumed once the connection to the at least one device is repaired, or as a processing can resume.

In step 507, the RAM 125 may cause, at least in part, a transmission of one or more alert messages from or by the at least one device to the at least one embedded system if the at least one device detects the one or more alerts outside of the distance threshold. In one embodiment, the RAM 125 may cause the transmission of one or more alert messages from the at least one device to the at least one embedded system if the at least one device detects the alerts outside of the distance threshold. Thus, in one embodiment, the one or more service operations may be carried out by the at least one device, so to reserve capacity for the at least one embedded system. However, in one scenario, the one or more alerts may be transferred as needed to the at least one embedded system. In multiple embodiments, the embedded system may discard alerts that are no longer relevant while accepting new alerts from the at least one device that are of recent relevance.

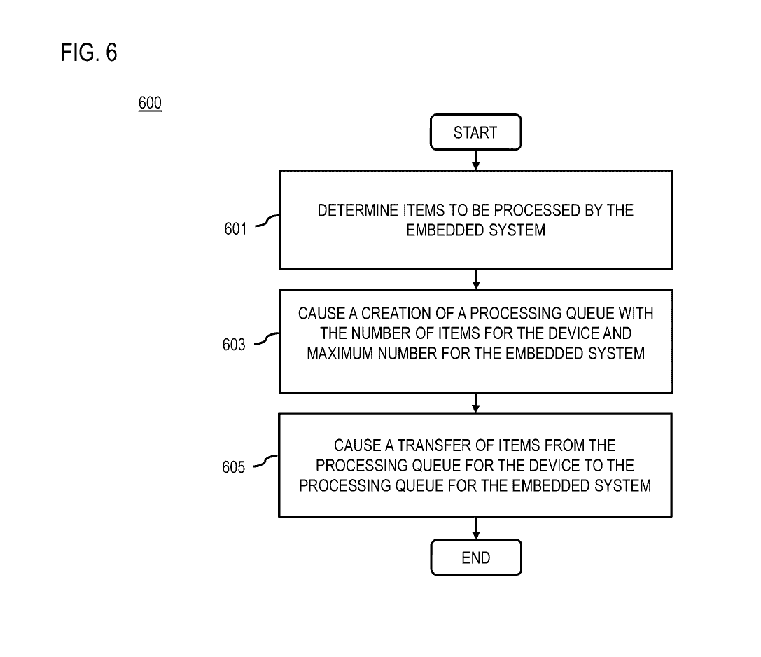

FIG. 6 is a flowchart of a process for determining additional items to be processed and the transfer of the additional items, according to one embodiment. In one embodiment, the RAM 125 performs the process 600 and is implemented in, for instance, a chip set including a processor and a memory as shown in FIG. 10. In one embodiment, the steps of the process 600 are optional steps that can be performed in combination with one or more steps of the process 300 of FIG. 3.

In step 601, the RAM 125 may cause the resource availability/capability and/or resource capability information to include, at least in part, information specifying a maximum number of items that can be processed by the at least one embedded system, and an actual number of items to process, which is greater than the maximum number of items. The maximum number of items and/or the actual number of items may include one or more navigation waypoint items, one or more navigation viapoint items, one or more media items, or a combination thereof. In one embodiment, the RAM 125 may determine if the actual number of items is greater than the maximum number of items. If so, in one scenario, the RAM 125 may create a processing queue of the actual number of items at the at least one device, and another processing queue of the maximum number of items at the at least one embedded system.

In step 603, the RAM 125 causes, at least in part, a creation of at least one processing queue of the actual number of items at or for the at least one device, and another processing queue of the maximum number of items at or for the at least one embedded system. In various embodiments, the at least one embedded system may specify a maximum number of items of one or more services, one or more processes, a combination thereof, or other like functions. These items for the embedded system may be included using one or more thresholds to determine the relative criticality of each of the items. In one scenario, the at least one device may include an actual number of items that exceed the maximum number of items. This actual number of items includes additional items of a lower criticality that may not be needed in the immediate future.

In step 605, the RAM 125 causes, at least in part, a transfer of one or more items from the at least one processing queue at or for the at least one device to the another processing queue at or for the at least one embedded system as the number of items in the another processing queue becomes less than the maximum number. In one embodiment, the RAM 125 may cause a transfer of one or more items from the at least one processing queue at the at least one device to the another processing queue at the at least one embedded system as the at least one embedded system processes and removes one or other items from the another processing queue. In other words, the embedded system may only include a set number of items of greater criticality or immediacy. For example, if the number of items exceeds this set maximum number, the additional items may be sent to the queue of at least one device for eventual processing. The items may be stored as a queue for the embedded system and the at least one device, respectively. When the queue of the embedded system is depleted below the maximum number of items, additional items may be transferred from the queue of the at least one device to the queue of the embedded system for a maintenance of the maximum number of items.

For example, at least one user may choose media of an entertainment service with a hundred songs to queue—in order—for a playlist. The embedded system may have a maximum number of 50 for a song playlist, and transfer the additional queued items to the at least one device. Thus, the 100 additional songs not initially included may be added to the embedded system from the at least one device—as a whole or stepwise. In one scenario, the additional actual items at the at least one device may be added to the embedded system as the items of the maximum number on the at least one embedded system are discarded.

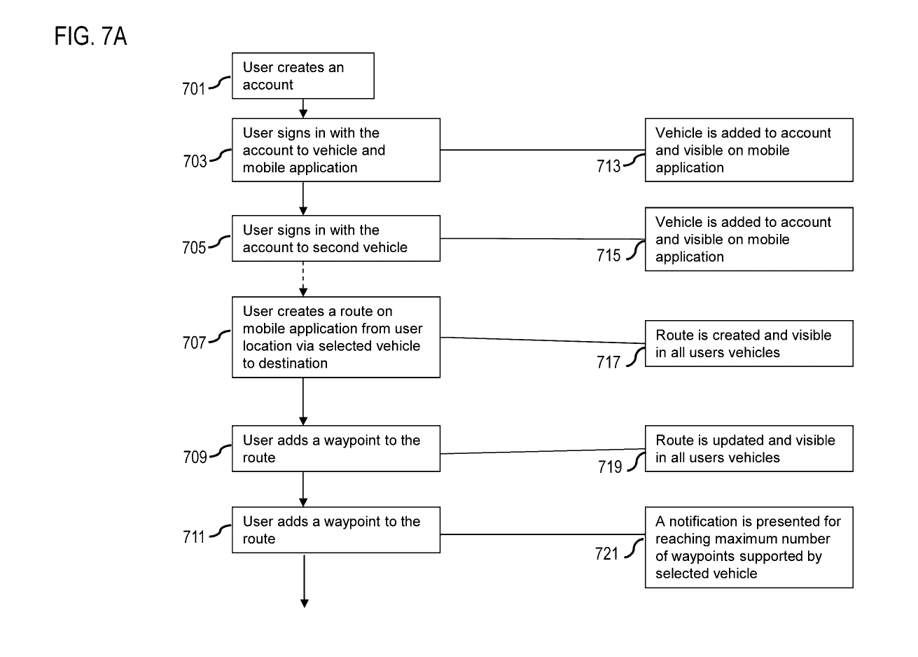

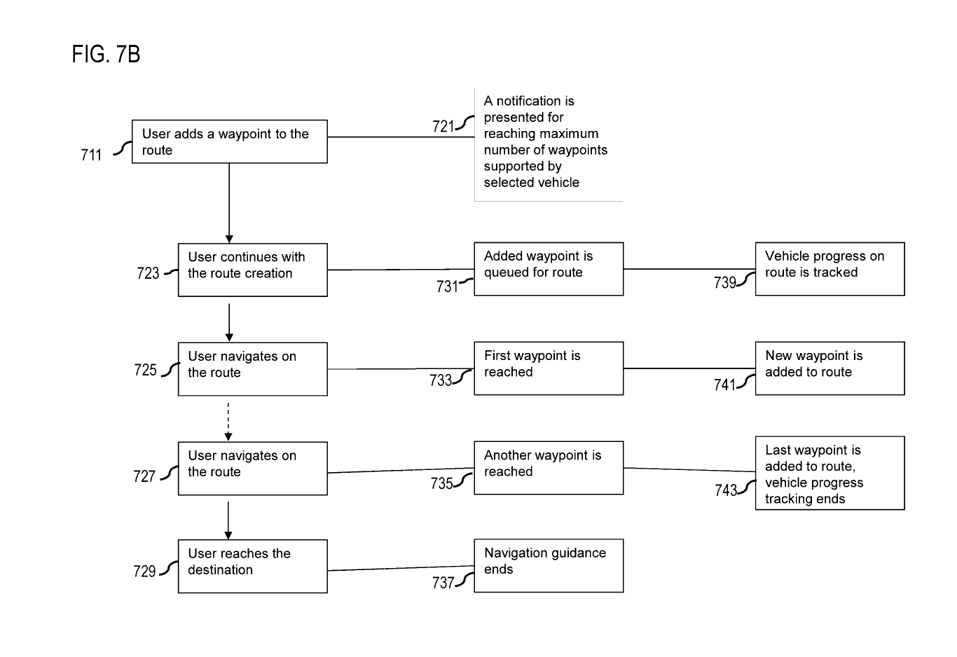

FIGS. 7A and 7B include flowchart diagrams for utilizing one or more processes of FIGS. 3 through 6, for providing an efficient resource load distribution for embedded systems, to support a creating of a multi-waypoint navigation route via a user device and synchronizing the route with an embedded system, according to various embodiments. As shown in FIG. 7A, a user may create an account (701) to personalize the resource availability/capability function and employ multiple steps for determining resource availability/capability associated with at least one embedded system and at least one device. First, a user may create an account (701) using one or more authentications, services, and other means known in the art. At any time the user may sign on to an account (703) which links the vehicle (embedded system) with one or mobile applications. The account may be visible on a display (713) of the embedded system or a mobile interface of the at least one device. In one scenario, the user may sign in with the same account to one or more other vehicles (705), which may be registered on a display (715) of an embedded system or a mobile interface of the at least one device. In one embodiment, a user may plan a route on a mobile device (707, 717) that is subsequently transferred to a least one vehicle as selected by the user. In one embodiment, the user may create a route by adding at least one navigation waypoint item to the route using the embedded system (709), at least one device, or a combination thereof. As one or more navigation waypoint items are added, the route is updated and visible to all users (719) in the vehicle. In one scenario, a notification may be presented when reaching a maximum number of navigation waypoint items supported by a selected vehicle (721). The presentation of the notification information may be incorporated into the user interface module (209) and the presentation module (213).

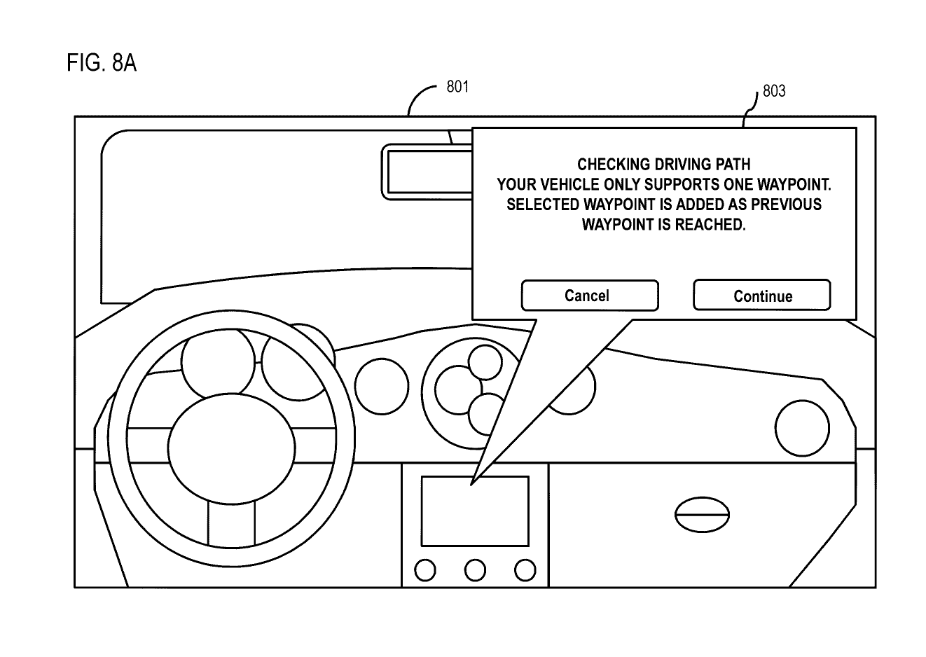

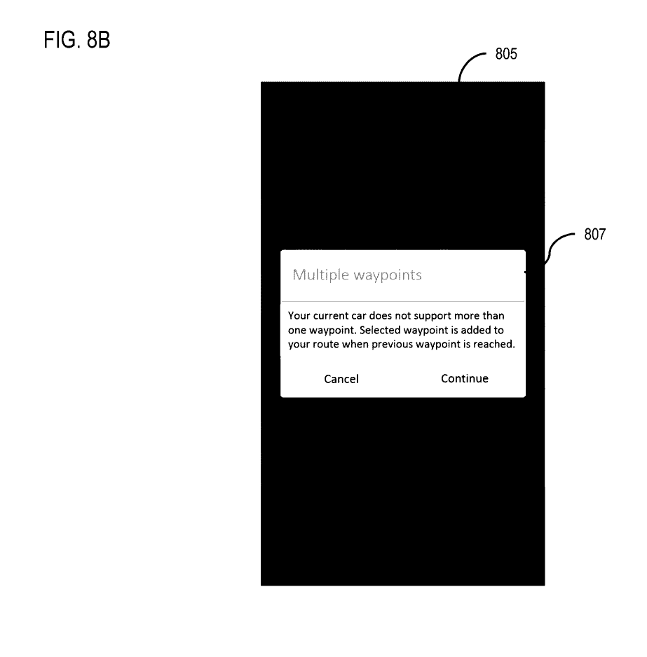

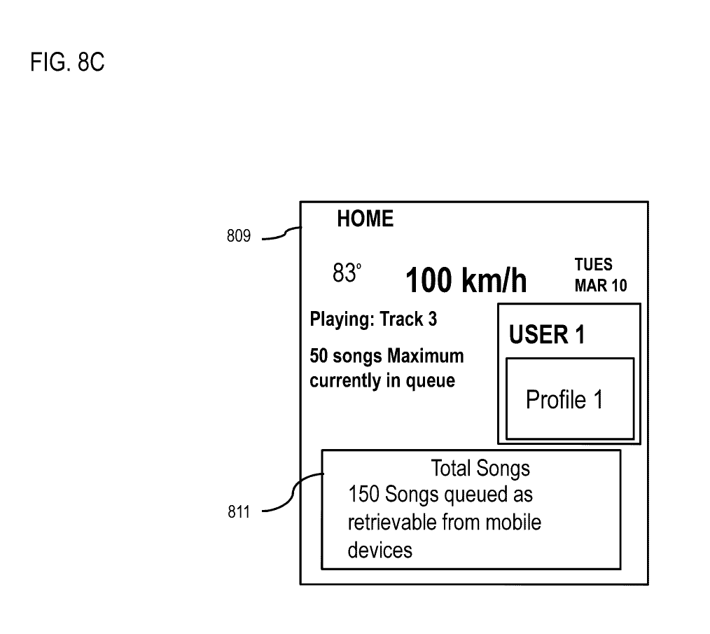

As shown in FIG. 7B, which continues from FIG. 7A, a user may continue to create one or more routes (723) by adding one or more navigation waypoint items to the route (731), while tracking the current progress of the vehicle (739). In one embodiment, as navigation continues (725), a first navigation waypoint item may be reached (733) and a new navigation waypoint item may be added (741) as the information associated with the first navigation waypoint item is discarded. In one scenario, the user may continue on the route (727) in this manner wherein new navigation waypoint items are reached (735) and the information associated with previous navigation waypoint items is discarded until a final selected navigation waypoint item is reached (743) and the navigation and resource availability service ends (729, 737). In one scenario, the navigation waypoint item information may be presented as an alert or notification to the user as is shown in FIG. 8A.

FIGS. 8A through 8C are user interface diagrams for efficient resource load distribution for embedded systems, according to various embodiments. FIG. 8A is a user interface diagram (801) for providing a notification as part of an optimized resource allocation for vehicle services, according to one embodiment. In the example of FIG. 8A, a user is driving along a calculated navigation route using the functions of the RAM 125. The RAM 125 may process resource availability/capability information of an embedded system and display a notification as to status of one or more resources (803). In this example, for navigation waypoint items (and navigation viapoint items) within the embedded systems capacity, the corresponding navigation information may be displayed that navigation waypoint items are available or the system may display a notification as to the capacity limits of the system for selected navigation waypoint items (803). Based on a selection of navigation waypoint item information, the RAM 125 may present information for when the maximum number of navigation waypoint items is reached that is supported by the selected vehicle. Furthermore, a notification may be presented that new waypoint information is added and/or that previously used navigation waypoint item information is being discarded. FIG. 8B illustrates a UI 805 on a UE 101 where a notification 807, similar to that of 803, is presented to a user of the UE 101.

FIG. 8C is a user interface diagram that represents a user equipment display for presenting resource availability/capability information, according to one embodiment. As shown, a user interface 809 may include resource availability/capability information (alerts) for situations where the at least one user (USER 1) may select more information than is currently available. For example, if the user is using an entertainment service for media items, such as for music, a notification may be sent for the maximum number of items in the embedded system as well as an actual (total) number of items that may be available. This actual number of items may include items (songs) that are stored on at least one device and may be sent to the embedded system as items (songs) from the maximum number of items are played and deleted. Accordingly, the UI 809 can be personalized to include an alert 811 indicating any such resources currently available (maximum) as well as a total potential number (actual).

The processes described herein for efficient resource load distribution for embedded systems may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

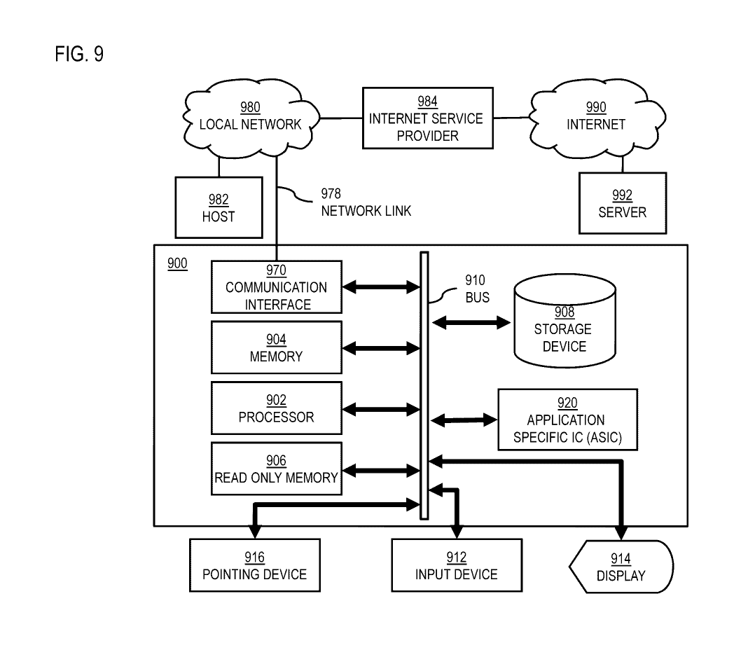

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to efficiently resource load distribution for embedded systems as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of efficient resource load distribution for embedded systems.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to efficiently resource load distribution for embedded systems. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for efficient resource load distribution for embedded systems. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for efficient resource load distribution for embedded systems, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for efficient resource load distribution for embedded systems.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to efficiently resource load distribution for embedded systems as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of efficient resource load distribution for embedded systems.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to efficiently resource load distribution for embedded systems. The memory 1005 also stores the data associated with or generated by the execution of the inventive steps.

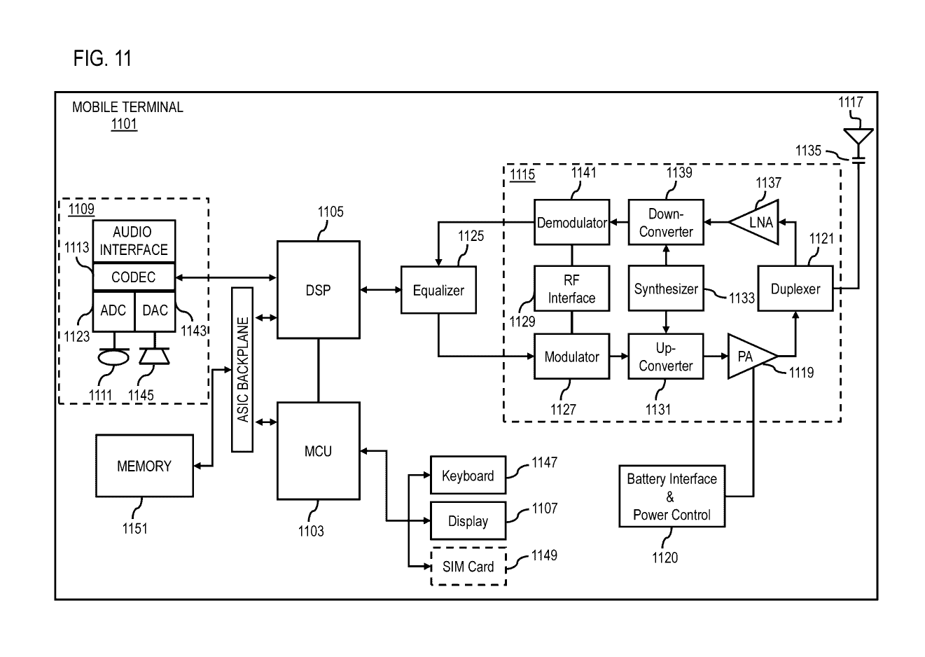

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of efficient resource load distribution for embedded systems. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of efficient resource load distribution for embedded systems. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to efficiently resource load distribution for embedded systems. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining resource availability information, resource capability information, or a combination thereof associated with at least one embedded system, at least one device with connectivity to the at least one embedded system, or a combination thereof;
causing, at least in part, a transfer of one or more services of the at least one embedded system to the at least one device based, at least in part, on the resource availability information, resource capability information, or a combination thereof; and causing, at least in part, a transmission of one or more service information updates to the at least one embedded system following the transfer,
wherein the one or more service information updates are used by the at least one embedded system to resume the one or more services when the one or more services are no longer provided by the at least one device.

2. A method of claim 1, wherein the transfer of the one or more services is further based, at least in part, on one or more transfer criteria, and wherein the one or more transfer criteria include, at least in part, a criticality of the one or more services, a distance threshold, or a combination thereof.

3. A method of claim 2, further comprising:
determining the criticality of the one or more services, the distance threshold, or a combination thereof based, at least in part, on one or more characteristics of the one or more services, one or more contextual situations, or a combination thereof.

4. A method of claim 2, further comprising:
determining the criticality of the one or more services based, at least in part, on whether the one or more services are driving-related or non-driving related.

5. A method of claim 4, wherein the one or more services that are classified as non-driving related are subject to the transfer from the at least one embedded system to the at least one device.

6. A method of claim 2, wherein the one or more services that are not imminent within the distance threshold are subject to the transfer from the at least one embedded system to the at least one device.

7. A method of claim 2, wherein the one or more services include, at least in part, one or more alert services, the method further comprising:
causing, at least in part, a retention of the one or more alert services at the at least one embedded system for detecting one or more alert events within the distance threshold; and
causing, at least in part, a transfer of the one or more alert services to the at least one device for detecting one or more alert events outside of the distance threshold.

8. A method of claim 7, further comprising:
causing, at least in part, a transmission of one or more alert messages to the at least one embedded system if the at least one device detects the one or more alerts outside of the distance threshold.

9. A method of claim 1, wherein the resource availability information, the resource capability information, or a combination thereof includes, at least in part, information specifying a maximum number of items that can be processed by the at least one embedded system, and the actual number of items to process is greater than the maximum number of items, the method further comprising:
causing, at least in part, a creation of at least one processing queue of the actual number of items for the at least one device, and another processing queue of the maximum number of items for the at least one embedded system; and
causing, at least in part, a transfer of one or more items from the at least one processing queue for the at least one device to the another processing queue for the at least one embedded system as the number of items in the another processing queue becomes less than the maximum number.

10. A method of claim 9, wherein the one or more items, the one or more other items, or a combination thereof include, at least in part, one or more navigation waypoint items, one or more navigation viapoint items, one or more media items, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine resource availability information, resource capability information, or a combination thereof associated with at least one embedded system, at least one device with connectivity to the at least one embedded system, or a combination thereof;
cause, at least in part, a transfer of one or more services of the at least one embedded system to the at least one device based, at least in part, on the resource availability information, resource capability information, or a combination thereof and
cause, at least in part, a transmission of one or more service information updates to the at least one embedded system following the transfer,
wherein the one or more service information updates are used by the at least one embedded system to resume the one or more services when the one or more services are no longer provided by the at least one device.

12. An apparatus of claim 11, wherein the transfer of the one or more services is further based, at least in part, on one or more transfer criteria, and wherein the one or more transfer criteria include, at least in part, a criticality of the one or more services, a distance threshold, or a combination thereof.

13. An apparatus of claim 12, further comprising:
determine the criticality of the one or more services, the distance threshold, or a combination thereof based, at least in part, on one or more characteristics of the one or more services, one or more contextual situations, or a combination thereof.

14. An apparatus of claim 12, further comprising:
determine the criticality of the one or more services based, at least in part, on whether the one or more services are driving-related or non-driving related.

15. An apparatus of claim 12, wherein the one or more services include, at least in part, one or more alert services, the method further comprising:
cause, at least in part, a retention of the one or more alert services at the at least one embedded system for detecting one or more alert events within the distance threshold; and
cause, at least in part, a transfer of the one or more alert services to the at least one device for detecting one or more alert events outside of the distance threshold.

16. An apparatus of claim 15, further comprising:
cause, at least in part, a transmission of one or more alert messages to the at least one embedded system if the at least one device detects the one or more alerts outside of the distance threshold.

17. An apparatus of claim 11, wherein the resource availability information includes, the resource capability information, or a combination thereof at least in part, information specifying a maximum number of items that can be processed by the at least one embedded system, and the actual number of items to process is greater than the maximum number of items, the method further comprising:
cause, at least in part, a creation of at least one processing queue of the actual number of items for the at least one device, and another processing queue of the maximum number of items for the at least one embedded system; and
cause, at least in part, a transfer of one or more items from the at least one processing queue for the at least one device to the another processing queue for the at least one embedded system as the number of items in the another processing queue becomes less than the maximum number.

18. A non-transitory computer-readable storage medium carrying one or more sequences of one or more instructions which, when executed by one or more processors, cause an apparatus to at least perform the following steps:
determine resource availability information, resource capability information, or a combination thereof associated with at least one embedded system, at least one device with connectivity to the at least one embedded system, or a combination thereof;
cause, at least in part, a transfer of one or more services of the at least one embedded system to the at least one device based, at least in part, on the resource availability information, resource capability information, or a combination thereof; and
cause, at least in part, a transmission of one or more service information updates to the at least one embedded system following the transfer,
wherein the one or more service information updates are used by the at least one embedded system to resume the one or more services when the one or more services are no longer provided by the at least one device.

19. A non-transitory computer-readable storage medium of claim 18, wherein the transfer of the one or more services is further based, at least in part, on one or more transfer criteria, and wherein the one or more transfer criteria include, at least in part, a criticality of the one or more services, a distance threshold, or a combination thereof.

20. A non-transitory computer-readable storage medium of claim 19, further comprising:
determining the criticality of the one or more services, the distance threshold, or a combination thereof based, at least in part, on one or more characteristics of the one or more services, one or more contextual situations, or a combination thereof.

21.-49. (canceled)
